(19) United States
(12) Patent Application Publication
(10) Pub. No.: US 2006/0208953 A1
(43) Pub. Date: Sep. 21, 2006

(54) Antenna

(76) Inventor: Kazuhiro Shibata, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/562,344

(22) PCT Filed: Aug. 5, 2004
(86) PCT No.: PCT/JP04/11256

§ 371 Date: May 25, 2006

(30) Foreign Application Priority Data
Aug. 6, 2003 (JP) 2003-288113

(51) Int. Cl. H01Q 1/00

(52) U.S. Cl. 343/729; 343/725; 343/906

(57) ABSTRACT

A broadband antenna that is non-directional in the horizontal plane and that is capable of receiving a broadband radio wave, especially receiving a signal of a broad band extending over several Gigahertz. An antenna has a brass spherical shell having a diameter of, for example, 10 mm, fitted, in a skewered state, to a rod of brass having a diameter of 2.5 mm. This rod is held upright by an insulating bushing of nylon resin fitted at a central portion of a conductive circular plate. A coaxial cable is connected via a connector to a connector sleeve on the bottom surface of the conductive circular plate, with the rod connected to a core wire while the conductive circular plate is connected to a shield wire.

### TECHNICAL FIELD OF THE INVENTION

The present invention relates to an antenna, and more specifically to a broad-band antenna that has no directivity on the horizontal plane.

### PRIOR ART

The inventor of this application has proposed a non-directional antenna in Japanese Laid-Open Patent Publication No. H10-65425 (1998). This antenna is an antenna device having, on the outer circumferential side of a rod provided upright at a central portion thereof, a plurality of curved plates that are curved in the shape of a substantially circular arc so as to be convex toward the outer peripheral side in the radial direction. The plurality of curved plates, in particular, permits receiving radio waves from any direction, provides no directivity, and permits efficiently receiving radio waves from any direction.

However, the structure is adopted in which this antenna is assembled so that the plurality of curved plates are arranged on the outer peripheral side of the rod. This requires a larger number of components used therein and involves bothersome assembly, thus resulting in a high-cost antenna. Moreover, this antenna has a drawback that the gain thereof is low due to a current generated by a radio wave that has been received by the plurality of curved plates.

Patent Publication 1: Japanese Laid-Open Patent Publication No. H10-65425 (1998)

### SUMMARY OF THE INVENTION

Problems to be Solved by the Invention

It is an object of the invention to provide a low-cost antenna that requires a small number of components used therein and that can be easily manufactured.

It is another object of the invention to provide the antenna that obtains a high gain.

It is another object of the invention to provide the antenna that is non-directional on a horizontal plane and that is capable of receiving radio waves from any direction.

It is still another object of the invention to provide the antenna that is capable of reliably receiving broadband radio waves, especially those broadly extending over several gigahertzes.

The problems described above and other problems will be clarified by technological ideas of the present invention and their embodiments.

Means for Solving the Problems

A main aspect of the present invention relates to the antenna including: an antenna element that is formed in a substantially spherical shape; a conductive rod that penetrates through the antenna element and that is electrically conducted to the antenna element; and a conductive circular plate that is disposed on the base end side of the conductive rod so as to be substantially orthogonal to the conductive rod, in which a feeding point is provided at a portion where the based end side of the conductive rod and the conductive circular plate intersect each other.

It is preferable that the antenna be a hollow spherical shell formed of conductive metal. It is also preferable that the spherical shell be formed with a slit substantially parallel to the axial direction of the conductive rod. It is also preferable that the spherical shell be a conductive layer that is formed on the outer circumferential surface of a support body formed of an insulating material. It is also preferable that the support body be a sphere of synthetic resin, on a surface of which the conductive layer is formed by plating. It is also preferable that the conductive layer be formed with a slit substantially parallel to the axial direction of the conductive rod.

It is further preferable that a plurality of antenna elements be fitted to the conductive rod. It is also preferable that an insulating bushing be fitted at a substantially central portion of the conductive circular plate and that the conductive rod is provided upright in a central opening of the insulating bushing. It is also preferable that a connecter sleeve be linked or fitted to the surface of the conductive circular plate on the side opposite to the surface thereof on which the conductive rod is provided upright, that the connector sleeve be screwed with a connector of a coaxial cable, and that a core wire of the coaxial cable be connected to the conductive rod while a shield wire thereof be connected to the conductive circular plate. It is also preferable that the antenna element be slidably fitted to the conductive rod and that the distance from the conductive circular plate to the antenna element can be changed.

According to another aspect of the present invention, in the antenna including of a reflecting plate formed in a parabolic shape and a primary radiator fitted to the focus of the reflecting plate, the primary radiator includes: the antenna element that is formed in the substantially spherical shape; the conductive rod that penetrates through the antenna element and that is electrically conducted to the antenna element; and the conductive circular plate that is disposed on the base end side of the conductive rod so as to be substantially orthogonal to the conductive rod.

According to still another aspect of the present invention, in the antenna including a dielectric lens and the primary radiator fitted to the focus of the dielectric lens, the primary radiator includes: the antenna element that is formed in the substantially spherical shape; the conductive rod that penetrates through the antenna element and that is electrically conducted to the antenna element; and the conductive circular plate that is disposed on the base end side of the conductive rod so as to be substantially orthogonal to the conductive rod.

The spherical shell or the sphere of the invention described above is not limited to a complete sphere, but may be formed into a spherical shape or a shape similar to the sphere, thus including a shape curved or deformed to some extent.

Effects of the Invention

The main aspect of the present invention is composed of the antenna element formed in the substantially spherical shape, the conductive rod, and the conductive circular plate, and the feeding point is provided at a portion where the base end side of the conductive rod and the conductive circular plate intersect each other. The structure is provided such that the antenna element itself is spherically formed and the conductive rod is combined together so as to penetrate through this spherically formed antenna element, thus resulting in a larger surface area of the antenna element, no directivity provided on the horizontal plane, and an extremely broad band. Moreover, providing the conductive circular plate and configuring the antenna element to be slidable with respect to the conductive rod permits freely changing the distance from the conductive circular plate to the antenna element, thus permitting favorable matching. This fact has been already confirmed by experiments. Further, since the antenna element is formed in a spherical shape, forming the antenna element with a sphere permits a drastic reduction in the number of components used therein.

According to another aspect of the present invention, in the antenna including a reflecting plate formed in the parabolic shape and the primary radiator fitted to the focus of the reflecting plate, the primary radiator includes: the antenna element that is formed in the substantially spherical shape; the conductive rod that penetrates through the antenna element and that is electrically conducted to the antenna element; and the conductive circular plate that is disposed on the base end side of the conductive rod so as to be substantially orthogonal to the conductive rod, thereby permitting achieving a favorable antenna suited for high-speed transmission of digital data. Moreover, in the antenna including the dielectric lens and the primary radiator fitted to the focus of the dielectric lens, the primary radiator includes: the antenna element that is formed in the substantially spherical shape; the conductive rod that penetrates through the antenna element and that is electrically conducted to the antenna element; and the conductive circular plate that is disposed on the base end side of the conductive rod so as to be substantially orthogonal to the conductive rod, thereby permitting achieving a favorable antenna suited for high-speed transmission of digital data.

### BRIEF DESCRIPTION OF THE DRAWINGS

FIG. 1 is a perspective view of an antenna according to a first embodiment of the present invention;

FIG. 2 is a vertical cross-sectional view of the first embodiment of the invention;

FIG. 3 is a graph showing return loss characteristics of the antenna according to the first embodiment of the invention;

FIG. 4 is a graph showing return loss characteristics of the antenna according to the first embodiment of the invention;

FIG. 5 is a graph showing another type of return loss characteristics of the antenna according to the first embodiment of the invention;

FIG. 6 is a graph showing another type of return loss characteristics of the antenna according to the first embodiment of the invention;

FIG. 7 is a graph of measurement results of directivity according to the first embodiment of the invention;

FIG. 8 is a graph of measurement results of directivity according to the first embodiment of the invention;

FIG. 9 is a graph of measurement results of directivity according to the first embodiment of the invention;

FIG. 10 is a vertical cross-sectional view of the antenna according to another embodiment of the invention;

FIG. 11 is a perspective view of main parts of the antenna element according to still another embodiment of the invention;

FIG. 12 is a vertical cross-sectional view of the antenna device using the antenna element according to still another embodiment of the invention;

FIG. 13 is a vertical cross-sectional view of an embodiment in which the antenna of the invention is used as the primary radiator of the parabolic antenna;

FIG. 14 is a vertical cross-sectional view of an embodiment in which the antenna of the invention is used as the primary radiator of the Luneberg lens antenna;

FIG. 15 is a graph of measurement results of directivity according to an embodiment in which the invention is used as the primary radiator of the Luneberg lens antenna;

FIG. 16 is a graph of measurement results of directivity according to an embodiment in which the invention is used as the primary radiator of the Luneberg lens antenna;

FIG. 17 is a graph of measurement results of directivity according to an embodiment in which the invention is used as the primary radiator of the Luneberg lens antenna;

FIG. 18 is a graph of measurement results of directivity according to an embodiment in which the invention is used as the primary radiator of the Luneberg lens antenna; and

FIG. 19 is a graph of measurement results of directivity according to an embodiment in which the invention is used as the primary radiator of the Luneberg lens antenna;

### DETAILED DESCRIPTION OF THE PREFERRED EMBODIMENTS

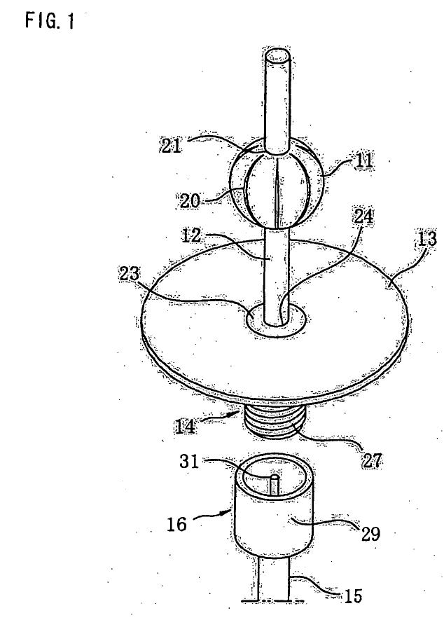

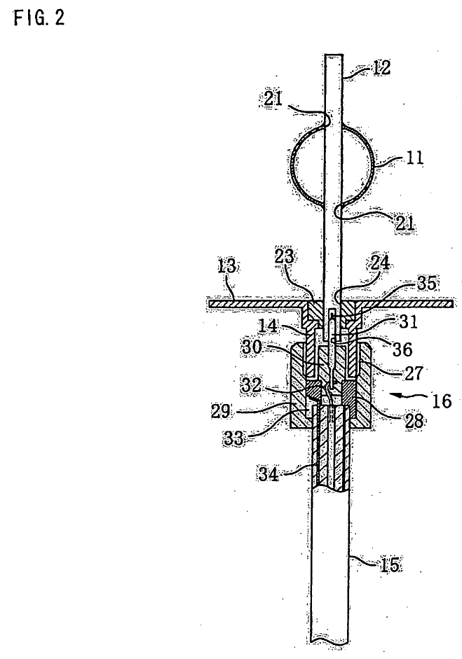

FIGS. 1 and 2 show the overall structure of the antenna according to one embodiment of the present invention. In the present embodiment, an antenna element 11 is used which is formed of a brass spherical shell having a diameter of 10 mm and a thickness of 0.2 mm. The antenna element 11 is provided on a rod 12 of brass having a diameter of, for example, 2.5 mm so that the rod 12 penetrates therethrough. The rod 12 is fitted on a conductive circular plate 13 of a brass discoid having a diameter of 30 mm so as to be provided upright. On the bottom surface of the conductive circular plate 13, a connector sleeve 14 is integrally linked. To this connector sleeve 14, a coaxial cable 15 is connected via a connector 16.

The antenna element 11 formed of the brass spherical shell has slits 20 having a width of 0.5 mm and formed on the outer circumferential surface thereof along the circumference thereof at intervals of 60 degrees. These slits 20 are formed in the vertical direction of the antenna element 11 and in the direction parallel to the rod 12. The antenna element 11 is fitted to the rod 12 in the skewered state by a through-hole 21 that have a diameter of 2.5 mm and that are respectively formed at the top and bottom of the antenna element 11. Thus, the antenna element 11 is slidably fitted to the rod 12, so that the distance from the conductive circular plate 13 to the antenna element 11 can be changed by sliding the antenna element 11 with respect to the rod 12. Shifting the distance from the conductive circular plate 13 to the antenna element 11 permits performing adjustment for achieving matching. In order to ensure the connection at the through-hole 21 between the antenna element 11 and the rod 12, it is preferable that this portion be soldered after antenna adjustment has been made.

The conductive circular plate 13 is formed of, for example, brass with a surface thereof coated with plating for corrosion protection. In the central portion of the conductive circular plate 13, an insulating bushing 23 of nylon resin is built by being press-fitted therein. This insulating bushing 23 has a central opening 24 through which the rod 12 penetrates. The insulating bushing 23 plays a role in insulating the rod 12 and the conductive circular plate 13 from each other.

On the outer circumferential surface of the connector sleeve 14, a male screw 27 is formed. The connector 16 to be connected via this male screw 27 includes, as shown in FIG. 2, a ring 28 of metal and a cap nut 29 rotatably fitted to the ring 28. In the central portion of this ring 28, an insulating holder 30 of synthetic resin is formed which holds a pin 31 in the central portion thereof. The pin 31 is connected to a core wire 32 of the coaxial cable 15.

In a predetermined circumferential position of the ring 28 of the connector 16, a cut 33 is formed, to which a shield wire 34 of the coaxial cable 15 is soldered. Thus, screwing the cap nut 29 with the male screw 27 of the connector sleeve 14 connects the shield wire 34 to the conductive circular plate 13. The pin 31 connected to the core wire 32 of the coaxial cable 15 is press-fitted in a central opening 36 that is formed at the lower end of the rod 12. In order that, in this press-fitting, the pin 31 is elastically pressure-bonded with the inner circumferential surface of the central opening 36, a slot 35 is formed at a portion located at the lower end of the rod 12 on the outer circumferential side of the central opening 36.

Such an antenna has the feeding point thereof located at a portion where the base end side of the rod 12 and the conductive circular plate 13 intersect each other. More specifically, at the portion where the base end side of the rod 12 and the conductive circular plate 13 intersect each other, via the connector sleeve 14 and the connector 16, the core wire 32 of the coaxial cable 15 is connected to the base end side of the rod 12 while the shield wire of the coaxial cable 15 is connected to the central portion of the conductive circular plate 13. Such the antenna has the antenna element 11 that is spherically formed. It is known that, with a monopole antenna, a larger diameter and a larger area of the antenna element permits a broader band for resonance and matching. Therefore, it is assumed that spherically forming the antenna element 11 results in a larger area of the antenna element 11, thus permitting achieving the broader band. Fitting the antenna element 11 slidably to the rod 12 permits changing the distance from the conductive circular plate 13 to the antenna element 11. It is assumed that the change in the distance from the conductive circular plate 13 to the antenna element 11 changes impedance, thus permitting matching adjustment.

Such the antenna seems to generate less reflected waves especially because a spherical shell is used as the antenna element 11. More specifically, in a case of the antenna element which is formed by combining together the conductive circular plate and a circular cone whose vertex is disposed face-to-face with the central portion of the conductive circular plate, reflected waves are generated at the end portion of the circular cone located at the upper end side where the diameter thereof is largest. Such reflected waves cause damage to the antenna performance. However, it is assumed that the use of a spherically formed antenna element generates almost no reflected waves due to the absence of the edge of the circular cone where the diameter thereof is largest, thereby providing a favorable performance.

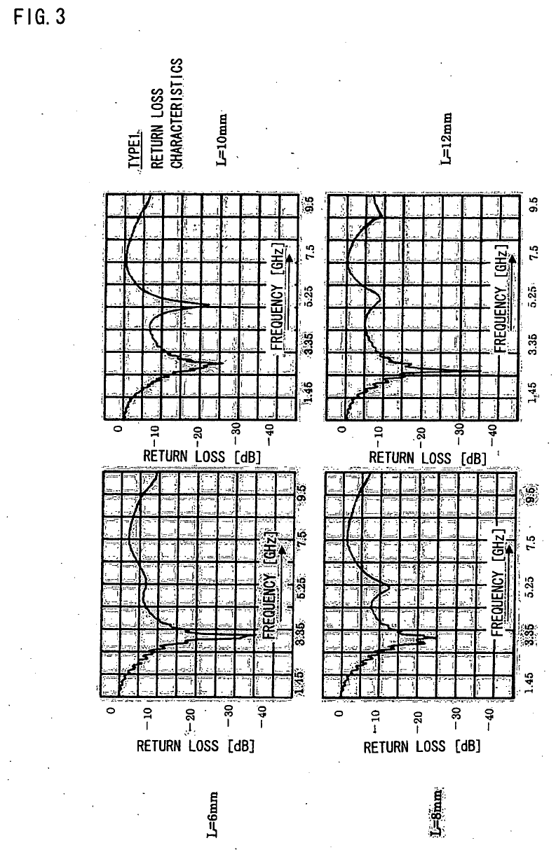

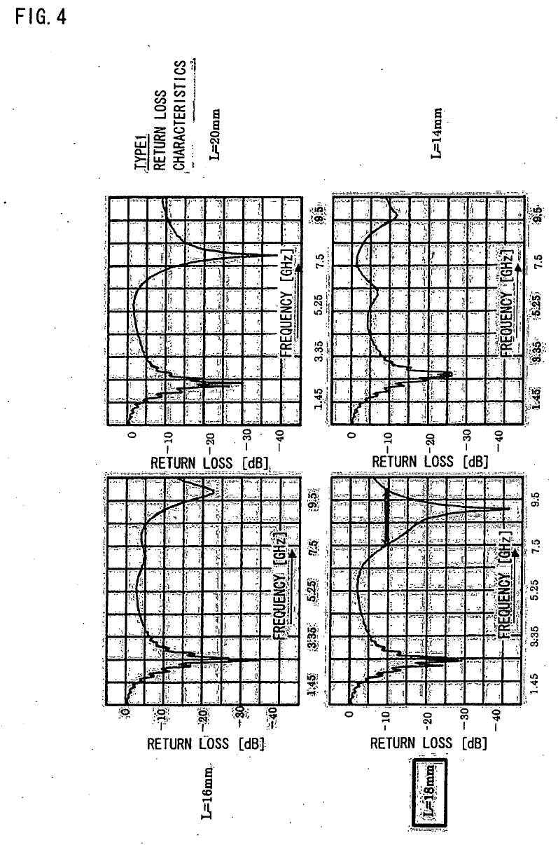

FIGS. 3 and 4 show results of return loss measured by using the antenna element 11 of the spherical shell having the diameter of 10 mm and formed at intervals of 60 degrees with 6 slits having the width of 0.5 mm and by defining as a parameter a distance (L) between the lower end of this antenna element 11 and the surface of the conductive circular plate 13. In each of FIGS. 3 and 4, the horizontal axis indicates a frequency while the vertical axis indicates return loss. FIG. 3 shows the measurement results when the distance (L) between the lower end of the antenna element 11 and the surface of the conductive circular plate 13 is 6 mm, 8 mm, 10 mm, and 12 mm, respectively. FIG. 4 shows the measurement results when the distance (L) between the lower end of the antenna element 11 and the surface of the conductive circular plate 13 is 14 mm, 16 mm, 18 mm, and 20 mm, respectively. These measurements results prove that adjusting the distance from the conductive circular plate 13 to the antenna element 11 on the rod 12 permits matching adjustment and an improvement in the return loss. For example, as shown in FIG. 4, when the distance between the antenna element 11 and the conductive circular plate 13 is 18 mm, in the broad band of 8-10 GHz, favorable results can be obtained such that the return loss becomes −10 dB or below and such that the voltage standing wave ratio (VSWR) becomes 2 or below.

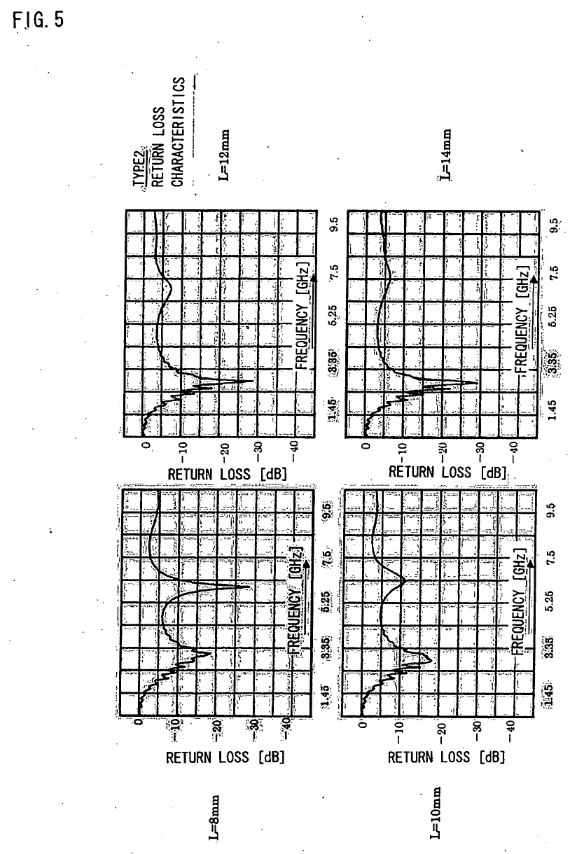

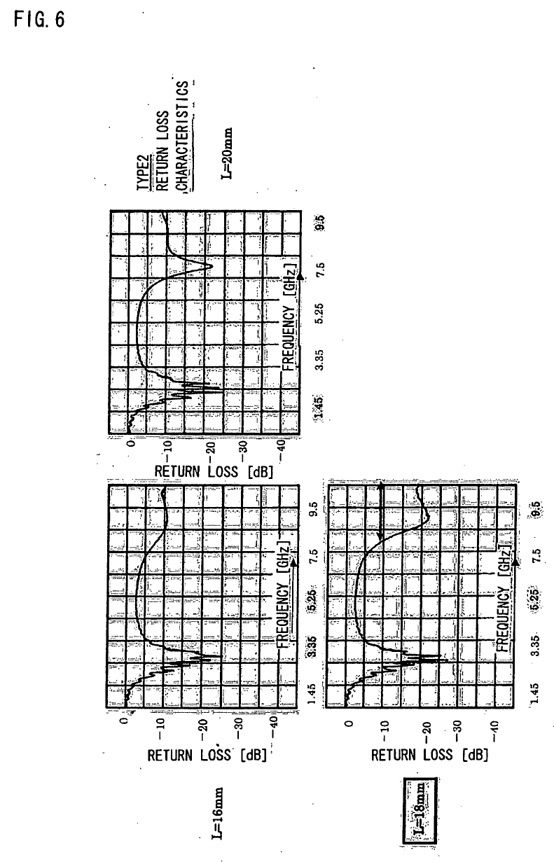

FIGS. 5 and 6 show the results of measurements performed in the same manner by using as the antenna element 11 having three slits formed at intervals of 60 degrees and each extending over through 60 degrees in the circumferential direction. FIG. 5 shows the measurement results when the distance (L) between the lower end of the antenna element 11 and the surface of the conductive circular plate 13 is 8 mm, 10 mm, 12 mm, and 14 mm, respectively. FIG. 6 shows the measurement results when the distance (L) between the lower end of the antenna element 11 and the surface of the conductive circular plate 13 is 16 mm, 18 mm, and 20 mm, respectively. Also with the antenna element 11 in this form, these measurements results also prove that adjusting the distance from the conductive circular plate 13 to the antenna element 11 on the rod 12 permits matching adjustment and an improvement in the return loss. Also in this case, when the fitting height of the antenna element 11 from the conductive circular plate 13 is 18 mm, favorable results can be obtained at bands of 8 GHz or above.

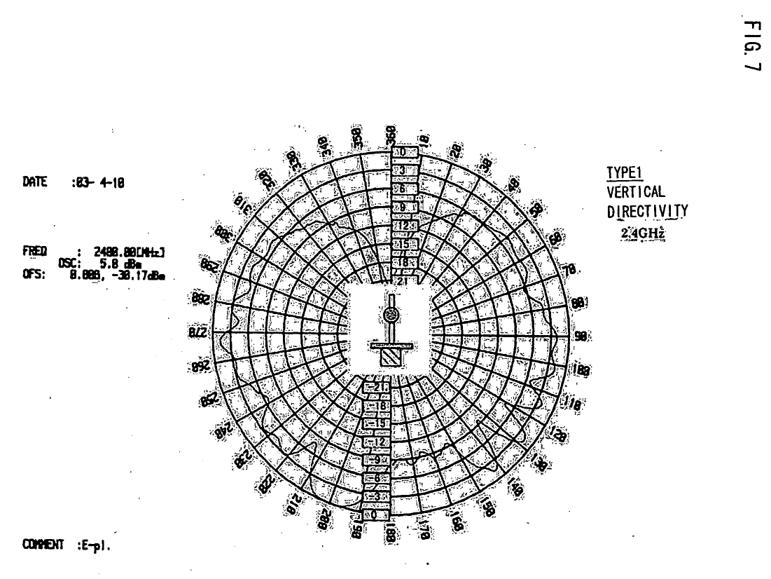

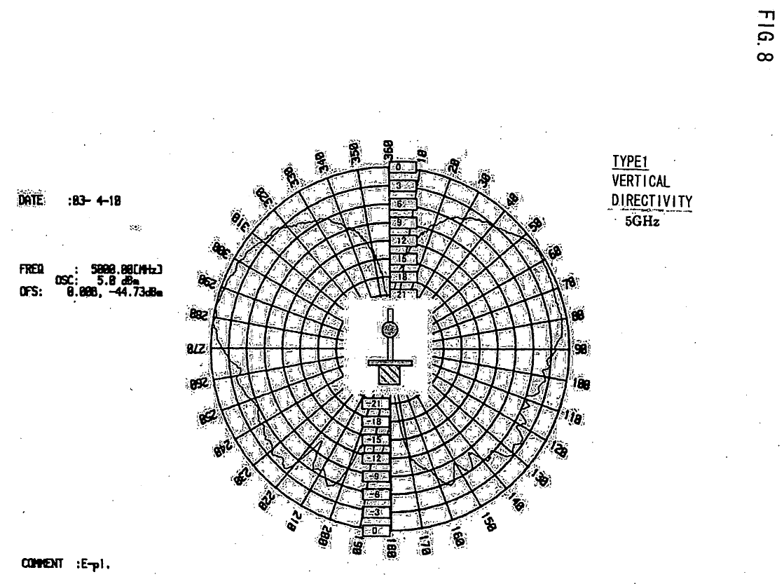

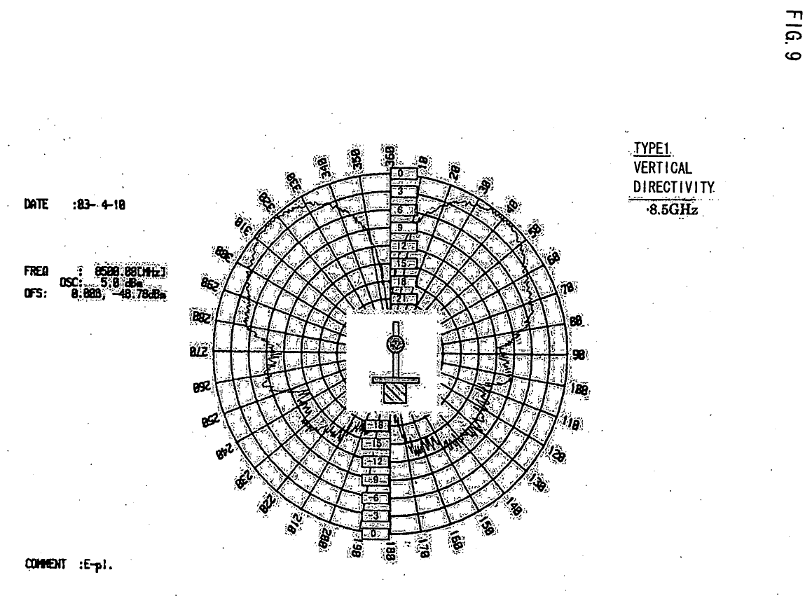

Next, the directivity on a vertical plane including the axial line of the rod 12 is measured, and then the results shown in FIGS. 7 to 9 are obtained. More specifically, FIG. 7 shows vertical directivity at 2.4 GHz. FIG. 8 shows vertical directivity at 5 GHz. FIG. 9 shows vertical directivity at 8.5 GHz. These data are all obtained through measurements under the condition that the fitting height of the antenna element 11 from the conductive circular plate 13 is 18 mm. The results of these measurements on the directivity have confirmed the directivity equivalent to that of a normal monopole antenna having a null formed on the front surface (in the axial direction). The characteristic at a frequency of as high as 8.5 GHz is such that, since the radius of the conductive circular plate 13 becomes larger with respect to the wavelength, the peak of the directivity appears in the horizontal direction, that is, at the position tilted through approximately 50 degrees with respect to 90 degrees and 270 degrees.

The gains of the antenna calculated based on the level difference from a horn antenna in the direction in which the directivity exhibits its peak are as shown below.

TABLE 1

| Frequency | Gain |
|---|---|
| 2.4 GHz | 2.5 dBi |
| 5.0 GHz | 2.3 dBi |
| 8.5 GHz | 5.5 dBi |

This antenna has no directivity and thus is non-directional in the horizontal direction, as is obvious from its structure. Therefore, this confirms that the antenna can be provided which is non-directional in the horizontal direction and of a broad band type.

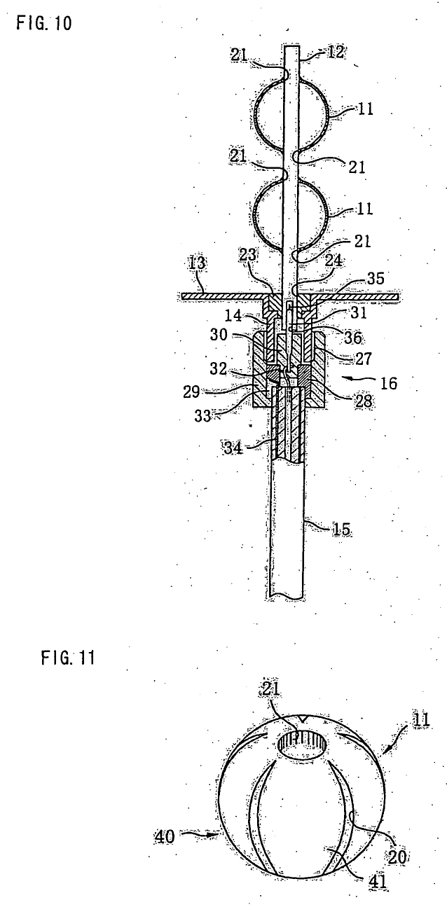

Next, a description will be given on another embodiment of the invention, referring to FIG. 10. In this embodiment, a plurality of antenna elements 11 are aligned vertically on the rod 12. In the present embodiment, the antenna element 11 having a diameter of 8 mm and the antenna element 11 having the diameter of 10 mm are fitted on the rod 12 with a distance of 5 mm between the ends of these antennas 11. The structure of the antenna element 11 is equal to that of the antenna element 11 in the first embodiment, and thus the antenna elements 11 in the present embodiment are each composed of a brass spherical shell with slits 20 vertically formed along the circumference thereof at intervals of 60 degrees.

When the plurality of antennas 11 are fitted on the rod 12 so as to be separated from each other, each of the antenna elements 11 performs reception operation or transmission operation in cooperation with the conductive circular plate 13. Therefore, it is assumed that an even broader band can be achieved than when only a single antenna element 11 is used.

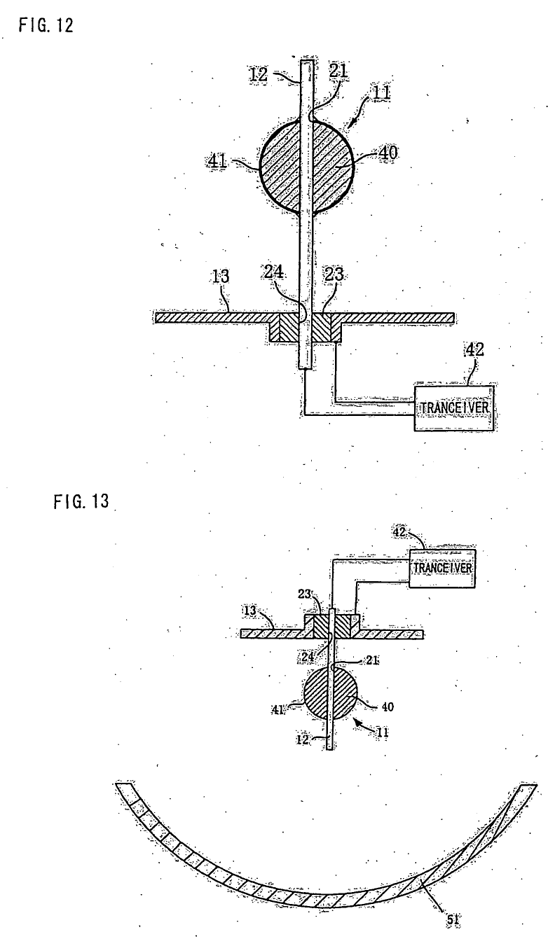

A description will be given on still another embodiment of the invention, with referring to FIGS. 11 and 12. In the present embodiment, a sphere of synthetic resin or ceramic, instead of a brass spherical shell, is used as the antenna element 11. More specifically, an insulating body 40 is formed with a spherical shell of a synthetic resin body or a ceramic body, on the surface of which a plating layer 41 is formed in a predetermined pattern. The plating layer 41 can be provided as the antenna element 11 by forming it on the conductive layer previously and selectively formed at a predetermined position on the surface of the insulating body 40. Alternatively, the plating layer 41 may be formed on the entire outer circumferential surface of the insulating body 40 of a sphere and then the plating layer 41 corresponding to the slits 20 may be removed by etching or the like. The insulating body 40 is provided with the through-hole 21 so formed as to penetrate therethrough in the axial direction thereof. Through this through-hole 21, the rod 12 is inserted.

As shown in FIG. 12, such the antenna element 11 having the plating layer 41 formed on the outer circumferential surface of the insulating body 40 thereof is fitted, in the skewered state, to the rod 12 provided upright by the insulating bushing 23 fitted at the central portion of the conductive circular plate 13. Both the rod 12 and the conductive circular plate 13 are respectively connected to both poles of a transceiver 42.

According to this structure, the antenna element 11 is formed by forming the plating layer 41 on the surface of the insulating body 40 of synthetic resin or ceramic in a predetermined pattern. This permits drastic reduction in costs of the antenna element 11 in particular, thereby providing a light-weight, low-cost antenna element.

FIG. 13 shows the antenna of the invention fitted as the primary radiator of the parabolic antenna. In FIG. 13, on the focus of a parabolic reflector 51, the antenna to which the present invention is applied is arranged. In this example, the antenna element 11 is composed of the plating layer 41 formed on the surface of the insulating body 40 of synthetic resin or ceramic. The conductive circular plate 13 is composed by forming a conductive layer 46 on the surface of a compact 45 of synthetic resin. Alternatively, the antenna element 11 and the conductive circular plate 13 may be formed of metal.

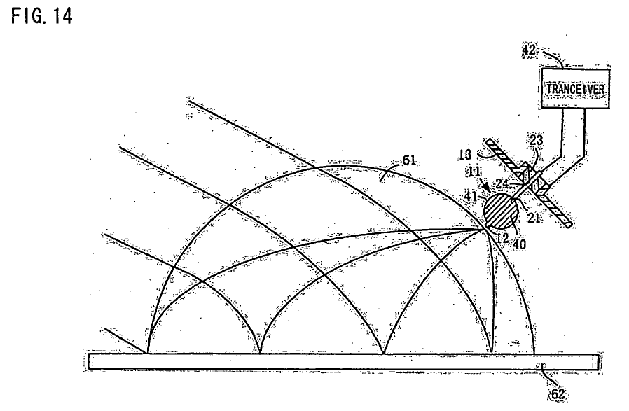

FIG. 14 shows the antenna of the invention fitted as the primary radiator of the antenna employing the Luneberg lens. The Luneberg lens is one kind of the dielectric lens, which can change the travel direction of an incident radio wave by changing the dielectric constant in accordance with the distance from the center of a spherical dielectric body, thus functioning as the antenna having uniform characteristics for radio waves from any direction.

In FIG. 14, on a reflecting plate 62, a Luneberg lens 61 in a semispherical shape is arranged. On the focus of the Luneberg lens 61, the antenna to which the present invention is applied is arranged. In this example, the antenna element 11 is composed of the plating layer 41 formed on the surface of the insulating body 40 of synthetic resin or ceramic. The conductive circular plate 13 is composed by forming the conductive layer 46 on the surface of the compact 45 of synthetic resin. Alternatively, the antenna element 11 and the conductive circular plate 13 may be formed of metal.

High-speed transmission and reception of a digital signal occupies a very broad band, thus requiring a very wide broadband communication. It is demanded in digital satellite broadcasting and digital satellite communication that the radio wave is transmitted or received efficiently by use of a parabolic antenna or a super-directional antenna, such as the lens antenna employing the Luneberg lens. As described above, the use of the antenna of the invention as the primary radiator of the parabolic antenna or as the primary radiator of the lens antenna employing the Luneberg lens can be applied to high-speed transmission of a digital signal in digital satellite broadcasting or digital satellite communication.

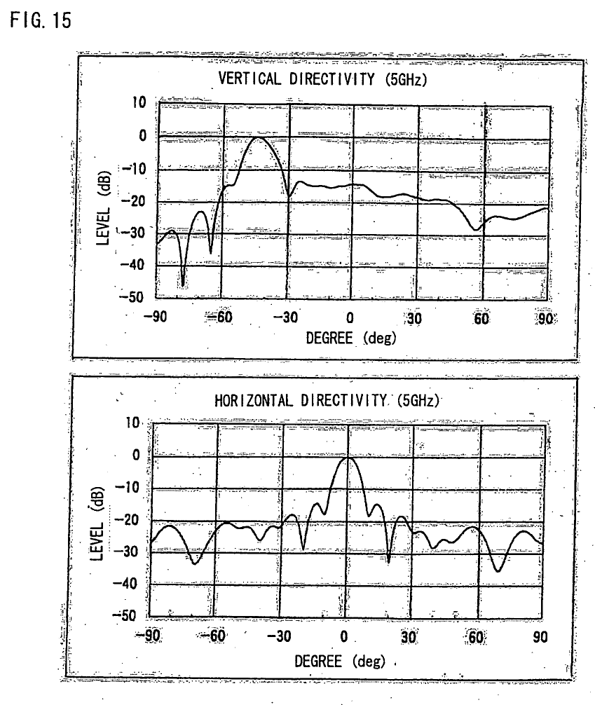

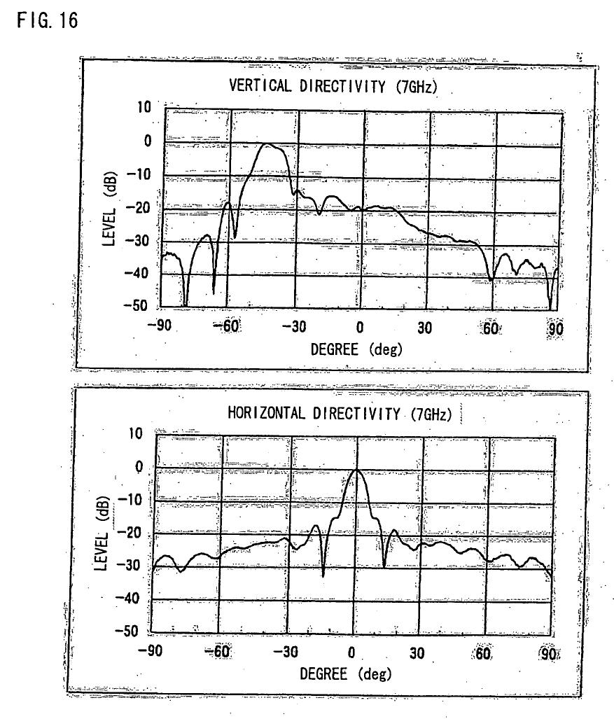

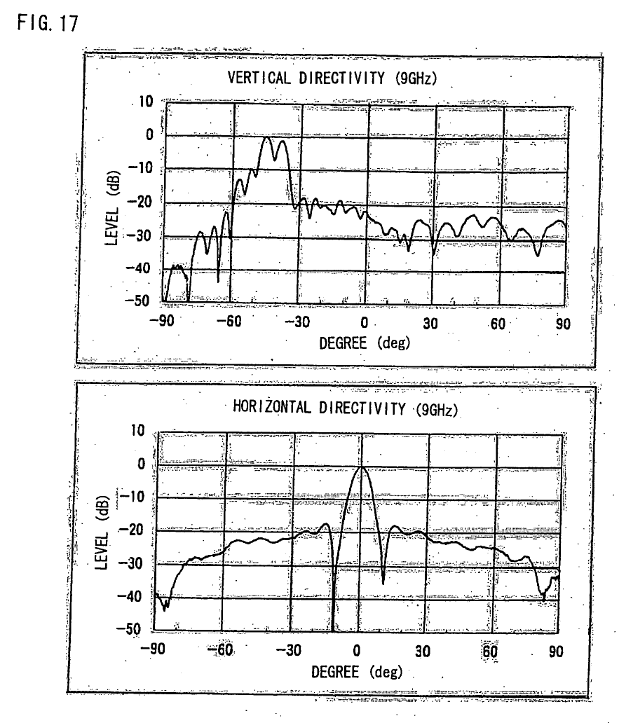

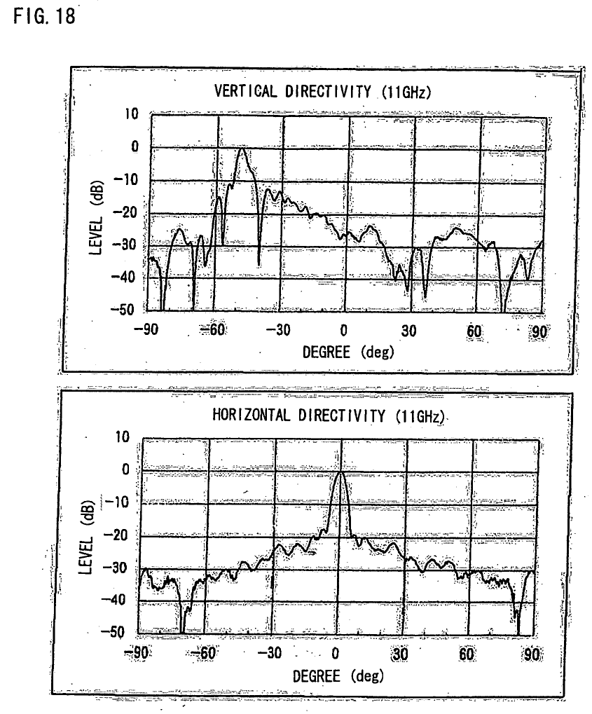

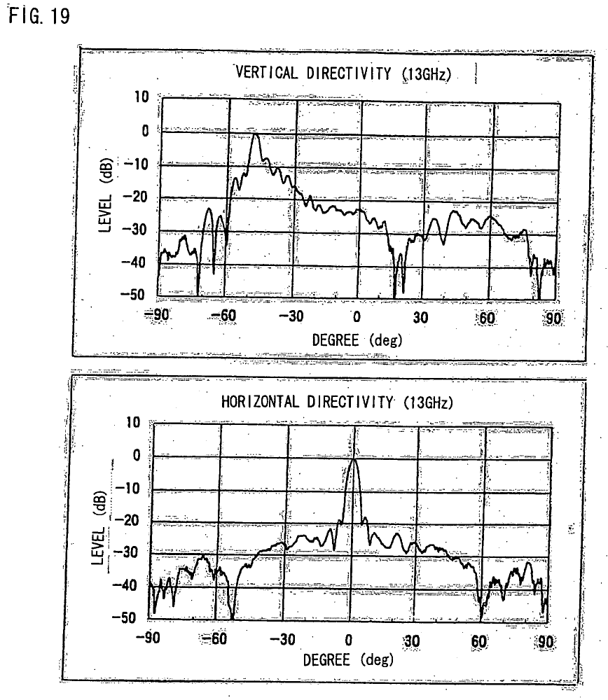

FIGS. 15 to 19 respectively show vertical directivity and horizontal directivity when the antenna of the invention is fitted as the primary radiator of the antenna employing the Luneberg lens shown in FIG. 14. FIG. 15 shows the vertical directivity and the horizontal directivity at a frequency of 5 Hz. FIG. 16 shows the vertical directivity and the horizontal directivity at a frequency of 7 Hz. FIG. 17 shows the vertical directivity and the horizontal directivity at a frequency of 9 Hz. FIG. 18 shows the vertical directivity and the horizontal directivity at a frequency of 11 Hz. FIG. 19 shows the vertical directivity and the horizontal directivity at a frequency of 13 Hz.

As is obvious from FIGS. 15 to 19 showing the directivity characteristic, since the antenna of the invention is non-directional, fitting the antenna of the invention as the primary radiator of the antenna using the Luneberg lens results in weaker directivity. The parabolic antenna or the lens antenna has too strong directivity, and thus is difficult to be used as the antenna for a movable body such as an automobile. By contrast, the use of the antenna of the invention as the primary radiator results in weaker directivity, which is favorable for use as the antenna for a movable body such as the automobile.

### INDUSTRIAL APPLICABILITY

An antenna according to the present invention is applicable as the antenna for wireless communication and, in particular, is preferably used for wireless communication for transmission and reception of a broad band digital signal, and is further preferable for reception of a digital signal of a picture for television broadcasting.

1. An antenna comprising:
an antenna element having a substantially spherical shape;
a conductive rod that penetrates through the antenna element and that is electrically connected to the antenna element; and
a conductive circular plate that is disposed on a base end side of the conductive rod substantially orthogonal to the conductive rod, wherein the antenna has a feeding point located where the base end side of the conductive rod and the conductive circular plate intersect each other.

2. The antenna according to claim 1, wherein the antenna element is a hollow spherical shell of conductive metal.

3. The antenna according to claim 2, wherein the spherical shell includes a slit substantially parallel to an axial direction of the conductive rod.

4. The antenna according to claim 2, wherein the spherical shell is a conductive layer on an outer circumferential surface of a support body of an insulating material.

5. The antenna according to claim 4, wherein the support body is a sphere of synthetic resin having a surface on which a plated conductive layer is disposed.

6. The antenna according to claim 4, wherein the conductive layer includes a slit substantially parallel to an axial direction of the conductive rod.

7. The antenna according to claim 1, including a plurality of antenna elements fitted to the conductive rod.

8. The antenna according to claim 1, including an insulating bushing fitted at a substantially central portion of the conductive circular plate, wherein the conductive rod is upright in a central opening of the insulating bushing.

9. The antenna according to claim 1, including a connector sleeve linked or fitted on a surface of the conductive circular plate on a side opposite to a surface of the conductive circular plate on which the conductive rod is located, wherein the connector sleeve is connected to a connector of a coaxial cable, a core wire of the coaxial cable is connected to the conductive rod, and a shield wire of the coatial cable is connected to the conductive circular plate.

10. The antenna according to claim 1, wherein the antenna element is slidably fitted on the conductive rod so that distance from the conductive circular plate to the antenna element can be changed.

11. An antenna comprising a reflecting plate having a parabolic shape and a primary radiator at a focus of the reflecting plate, wherein the primary radiator comprises:
an antenna element having a substantially spherical shape;
a conductive rod that penetrates through the antenna element and that is electrically connected to the antenna element; and
a conductive circular plate disposed on a base end side of the conductive rod, substantially orthogonal to the conductive rod.

12. An antenna comprising a dielectric lens and a primary radiator at a focus of the dielectric lens, wherein the primary radiator comprises:
an antenna element having a substantially spherical shape;
a conductive rod that penetrates through the antenna element and that is electrically connected to the antenna element; and
a conductive circular plate disposed on the base end side of the conductive rod, substantially orthogonal to the conductive rod.

13. The antenna according to claim 5, wherein the conductive layer includes a slit substantially parallel to an axial direction of the conductive rod.

14. The antenna according to claim 7, including an insulating bushing fitted at a substantially central portion of the conductive circular plate, wherein the conductive rod is upright in a central opening of the insulating bushing.

15. The antenna according to claim 7, including a connector sleeve linked or fitted on a surface of the conductive circular plate on a side opposite to a surface of the conductive circular plate on which the conductive rod is located, wherein the connector sleeve is connected to a connector of a coaxial cable, a core wire of the coaxial cable is connected to the conductive rod, and a shield wire of the coatial cable is connected to the conductive circular plate.

16. The antenna according to claim 7, wherein the antenna element is slidably fitted on the conductive rod so that distance from the conductive circular plate to the antenna element can be changed.
